(19) United States
(12) Patent Application Publication
(10) Pub. No.: US 2010/0011097 A1
(43) Pub. Date: Jan. 14, 2010

(54) Methods of Using Control Communications to Identify Devices that are Connected Through a Communications Patching System and Related Communications Patching Systems

(76) Inventor: Terry Cobb, Plano, TX (US)

Correspondence Address: MYERS BIGEL SIBLEY & SAJOVEC, P.O. BOX 37428, RALEIGH, NC, 27612, US

(21) Appl. No.: 12/171,721

(22) Filed: Jul. 11, 2008

(51) Int. Cl. G06F 15/173

(52) U.S. Cl. 709/223

(57) ABSTRACT

Methods of identifying a first networked computing device that is connected to a connector port of a communication patching system are provided in which a control communication that is transmitted by the first networked computing device is passed through the connector port. An identifier associated with the first networked computing device is extracted from this control communication. The identifier may then be logged in a connectivity database that associates the identifier with the connector port.

### FIELD OF THE INVENTION

The present invention relates generally to communications patching systems and, more particularly, to methods for identifying devices that are connected through such communications patching systems.

### BACKGROUND

Many businesses have dedicated communications systems that enable computers, servers, printers, facsimile machines and the like to communicate with each other, through a private network, and with remote locations via a telecommunications service provider. Such communications system may be hard wired through, for example, the walls and/or ceilings of the building that houses the business using communications cables that typically contain eight conductive wires. The eight conductive wires are arranged as four differential twisted pairs of conductors that may be used to transmit four separate differential signals. In such hard wired systems, individual connector ports such as RJ-45 style modular wall jacks are mounted in offices throughout the building. The communications cables electrically connect each connector port to network equipment (e.g., network servers, switches, etc.) that may be located in a computer room. Communications cables from external telecommunication service providers may also terminate within the computer room.

The communication cables may be connected to the network equipment through a communications patching system. Typically, a communications patching system includes a plurality of “patch panels” that are mounted on one or more equipment racks. As is known to those of skill in the art, a “patch panel” refers to an inter-connection device that includes a plurality of connector ports such as, for example, RJ-45 style communications jacks, on a front side thereof. Each connector port (e.g., a jack) is configured to receive a first communications cable that is terminated with a mating connector (e.g., a plug). Typically, a second communications cable is terminated into the reverse side of each connector port by terminating the eight conductive wires of the cable into corresponding insulation displacement contacts of the connector port. Each connector port on the patch panel may provide communications paths between a communications cable that is plugged into the front side of the connector port and a respective one of the communications cables that is terminated into the reverse side of the connector port. The communications patching system may optionally include a variety of additional equipment such as rack managers, system managers and other devices that facilitate making and/or tracking interconnections between networked devices.

FIG. 1 is a simplified example of one way in which a communications patching system may be used to connect a computer (or other device) 26 located in an office 4 of a building to network equipment 52, 54 located in a computer room 2 of the building. As shown in FIG. 1, the computer 26 is connected by a patch cord 28 to a modular wall jack 22 that is mounted in a wall plate 24 in office 4. A communications cable 20 is routed from the back end of the modular wall jack 22 through, for example, the walls and/or ceiling of the building, to the computer room 2. As there may be hundreds or thousands of wall jacks 22 within an office building, a large number of cables 20 are routed into the computer room 2.

A first equipment rack 10 is provided within the computer room 2. A plurality of patch panels 12 are mounted on the first equipment rack 10. Each patch panel 12 includes a plurality of connector ports 16. In FIG. 1, each connector port 16 comprises a modular RJ-45 jack that is configured to receive a modular RJ-45 plug connector. However, it will be appreciated that other types of patch panels may be used such as, for example, patch panels with RJ-11 style connector ports 16.

As shown in FIG. 1, each communications cable 20 that provides connectivity between the computer room 2 and the various offices 4 in the building is terminated onto the back end of one of the connector ports 16 of one of the patch panels 12. A second equipment rack 30 is also provided in the computer room 2. A plurality of patch panels 12′ that include connector ports 16′ are mounted on the second equipment rack 30. A first set of patch cords 40 (only two exemplary patch cords 40 are illustrated in FIG. 1) are used to interconnect the connector ports 16 on the patch panels 12 to respective ones of the connector ports 16′ on the patch panels 12′. The first and second equipment racks 10, 30 may be located in close proximity to each other (e.g., side-by-side) to simplify the routing of the patch cords 40. In the simplified example of FIG. 1, the communication patching system comprises the patch panels 12, 12′ and the patch cords 40.

As is further shown in FIG. 1, network equipment such as, for example, one or more switches 52 and network routers and/or servers 54 (“network devices”) are mounted on a third equipment rack 50. Each of the switches 52 may include a plurality of connector ports 53. A second set of patch cords 60 connect the connector ports 53 on the switches 52 to the back end of respective ones of the connector ports 16′ on the patch panels 12′. As is also shown in FIG. 1, a third set of patch cords 64 may be used to interconnect other of the connector ports 53 on the switches 52 with connector ports 55 provided on the network devices 54. In order to simplify FIG. 1, only a single patch cord 60 and a single patch cord 64 are shown. One or more external communications lines 66 may be connected to, for example, one or more of the network devices 54 (either directly or through a patch panel).

The communications patching system of FIG. 1 may be used to connect each computer, printer, facsimile machine, internet telephones and the like 26 located throughout the building to the network switches 52, the switches 52 to network routers 54, and the network routers 54 to external communications lines 66, thereby establishing the physical connectivity required to give devices 26 access to both local and wide area networks. In the communications patching system of FIG. 1, connectivity changes are typically made by rearranging the patch cords 40 that interconnect the connector ports 16 on the patch panels 12 with respective of the connector ports 16′ on the patch panels 12′.

The equipment configuration shown in FIG. 1, in which each wall jack 22 is connected to the network equipment 52, 54 through at least two patch panels 12, 12′, is referred to as a “cross-connect” patching system. In another commonly used equipment configuration, which is typically referred to as an “inter-connect” patching system, the communications path from each modular wall jack 22 to the network devices 54 typically passes through a single patch panel 12.

FIG. 2 depicts a simplified version of an inter-connect patching system that is used to connect a plurality of computers (and other networked computing devices) 126 located in the rooms 104 throughout an office building to a plurality of network devices 154 that are located in a computer room 102 of the building. As shown in FIG. 2, a plurality of patch panels 112 are mounted on a first equipment rack 110. Each patch panel 112 includes a plurality of connector ports 116. A plurality of communications cables 120 are routed from wall jacks 122 in the offices 104 into the computer room 102 and connected to the reverse side of respective of the connector ports 16 on the patch panels 112. The computers 126 are connected to respective of the modular wall jacks 122 by patch cords 128.

As is further shown in FIG. 2, network equipment such as, for example, one or more network devices 154, are mounted on a second equipment rack 150. One or more external communications lines 166 are connected to one or more of the network devices 154. A plurality of switches 152 that include a plurality of connector ports 153 are also provided. The switches 152 may be connected to the network devices 154 using a first set of patch cords 164 (only one patch cord 164 is shown in FIG. 2). A second set of patch cords 160 (only one patch cord 160 is shown in FIG. 2) is used to interconnect the connector ports 116 on the patch panels 112 with respective of the connector ports 153 on the switches 152. In the patching system of FIG. 2, connectivity changes are typically made by rearranging the patch cords 160 that interconnect the connector ports 116 on the patch panels 112 with respective of the connector ports 153 on the switches 152.

The patch cords in communications patching systems may be rearranged frequently. The patch cord interconnections are typically logged in a computer-based log that records changes made to the patch cord connections in order to keep track of, for example, the networked computing device (i.e., the computers 26 and other equipment of FIG. 1 that are located in the offices 104) that is connected to each connector port on each switch (i.e., the switches 52 of FIG. 1). However, technicians may neglect to update the log each and every time a change is made, and/or may make errors in logging changes. As such, the logs may not be 100 percent accurate.

A variety of systems have been proposed for automatically logging the patch cord connections in a communications patching system, including techniques that use mechanical switches, radio frequency identification and the like. Unfortunately, however, many of these known methods are unsuitable for inter-connect patching systems because the switch manufacturers generally do not provide patch cord tracking capabilities on commercially available switches. Existing methods for automatically logging patch cord connections also, in many cases, only automatically detect changes to the patch cord interconnections in the computer room and hence may not detect or log connection changes that occur in other parts of the building (i.e., when the computer 26 of FIG. 1 is replaced with a different computer).

### SUMMARY

According to certain embodiments of the present invention, methods of identifying a first networked computing device that is connected to a connector port of a communications patching system are provided. Pursuant to these methods, a control communication that is transmitted by the first networked computing device is passed through the connector port. An identifier associated with the first networked computing device is extracted from the control communication. The identifier is then logged in a connectivity database that associates the identifier with the connector port.

In some embodiments, the identifier is extracted at the connector port. The identifier may be extracted using a probe that is connected to at least one conductor of a differential pair of conductors that pass the control communication through the connector port. The probe may be, for example, a current probe or a high impedance differential probe. The connectivity database may track connectivity information within the communications patching system. The control communication may be an auto-negotiation communication that comprises at least one burst of fast link pulses, and the identifier may be a Medium Access Control (“MAC”) address.

The method may further include passing a second control communication that is transmitted by a second networked computing device through the connector port, extracting a second identifier that is associated with the second networked computing device from the second control communication, and then logging the second identifier in the connectivity database. The second identifier may be extracted using a second probe that is connected to at least one conductor of a second differential pair of conductors that pass the second control communication through the connector port. In some embodiments, the second identifier may be a MAC address associated with the second networked computing device and a port number of a connector port on the second networked computing device.

Pursuant to further embodiments of the present invention, methods of identifying a first device that is connected through a communications patching system are provided. In these methods, an identifier associated with a first device is embedded within a control communication that is transmitted from the first device to a second device via a connector port of a patch panel of a communications patching system. This identifier is extracted at the connector port. The identifier may be, for example, a MAC address of the first device. The control communication may be an auto-negotiation communication that is transmitted at the physical layer of the network protocol without input from higher layers of the network protocol. The identifier may be extracted using a probe that is connected to at least one conductor of a differential pair of conductors that are part of the connector port. The methods may further include reading the identifier from an output of the probe and logging the read identifier in a database that associates the identifier with the connector port.

Pursuant to still further embodiments of the present invention, communications patching systems are provided that include a patch panel that comprises a plurality of connector ports and a plurality of probes and a processor. In these patching systems, each probe is configured to extract information from control communications that are transmitted through a respective one of the connector ports that is associated with the probe. Moreover, the processor is coupled to the plurality of probes and is configured to read device identifiers that are contained within the extracted information.

In some embodiments, the connector ports comprise RJ-45 style connector ports that each include at least eight conductive paths. Each of the plurality of probes may be, for example, a current probe or a high impedance differential probe. These communications patching system may also include a plurality of comparators, where each comparator is connected between a respective one of the probes and the processor. In some embodiments, the communications patching system also includes a plurality of digital pulse detectors, where each digital pulse detector is connected between a respective one of the comparators and the processor.

### BRIEF DESCRIPTION OF THE DRAWINGS

FIG. 1 is a schematic view of a simplified prior art cross-connect communications patching system.

FIG. 2 is a schematic view of a simplified prior art inter-connect communications patching system.

FIG. 3 is a schematic diagram depicting a communications patching system according to certain embodiments of the present invention.

FIG. 4 is a flow chart illustrating methods of identifying the networked computing devices that are connected to a connector port of a communications patching system according to some embodiments of the present invention.

FIG. 5 is a schematic diagram of a series of fast link pulses that are transmitted across the physical layer of a network( connection as part of an auto-negotiation process.

FIG. 6 is a block diagram that illustrates an extraction circuit that may be used to extract an identifier from a control communication according to embodiments of the present invention.

### DETAILED DESCRIPTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

Embodiments of the present invention are described below with reference to flowchart illustrations and/or block diagrams. It will be understood that some blocks of the flowchart illustrations and/or block diagrams may be combined or split into multiple blocks, and that the blocks in the flow chart diagrams need not necessarily be performed in the order illustrated in the flow charts.

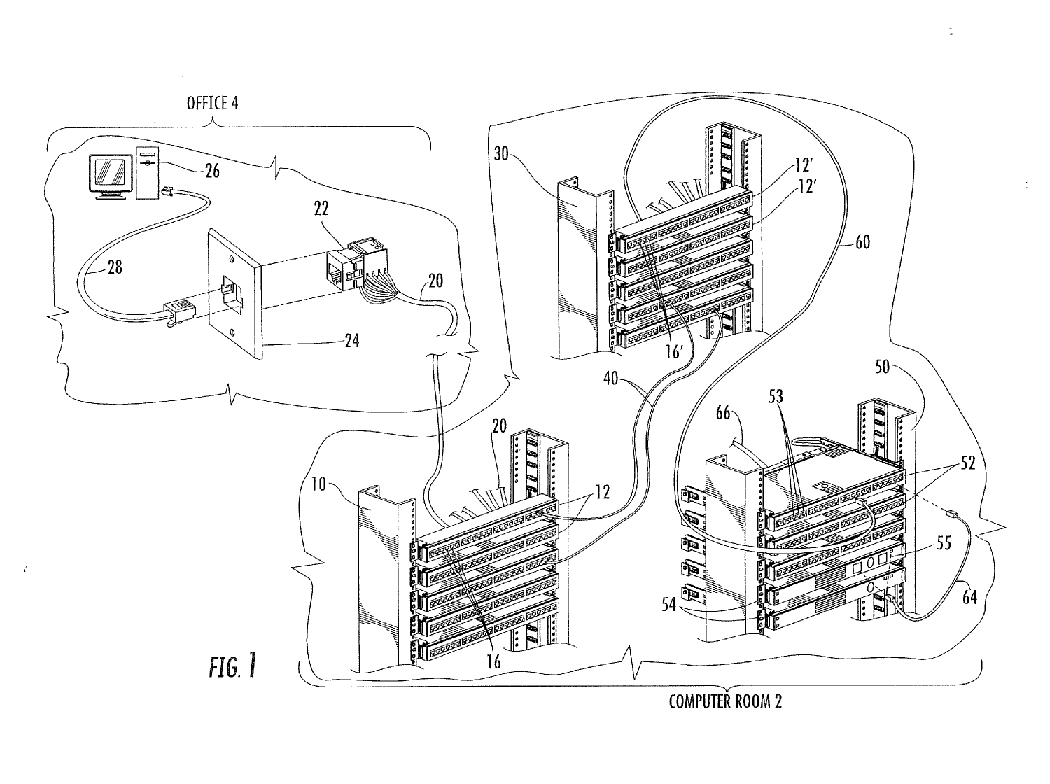

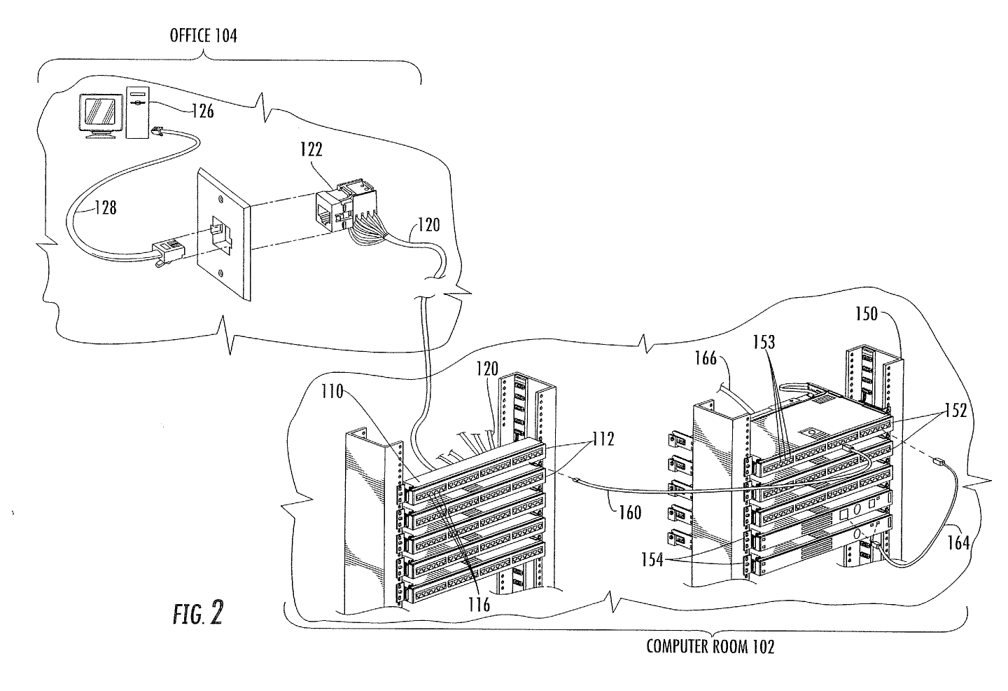

Pursuant to embodiments of the present invention, methods are provided for tracking connectivity information in communications patching systems. These methods can automatically determine the actual devices that are connected through each connector port in the communications patching system. By way of example, when the methods of the present invention are implemented in the prior art system of FIG. 1, the upgraded communications patching system may automatically determine an identifier (e.g., a MAC address) of the computer 26 and an identifier (e.g., the MAC address and port number) of the switch 52 to which the computer 26 is connected. These identifiers may be extracted by the system from control communications that are exchanged between computer 26 and switch 52 as those control communications pass through the specific connector port 16 on the patch panel 12 that is connected to computer 26 via patch cord 28 and cable 20 and/or when the control communications pass through the specific connector port 16′ on the patch panel 12′ that is connected to the switch 52 via patch cord 60. In this manner, the specific devices that are connected to each connector port in the communications patching system may be automatically determined. As will also be apparent from the description below, the methods are equally applicable to inter-connect patching systems, and hence can be used in systems having the configuration of FIG. 2 as well as cross-connect systems such as the system of FIG. 1. Communications patching systems and patch panels that can automatically perform these methods are also provided as part of this disclosure.

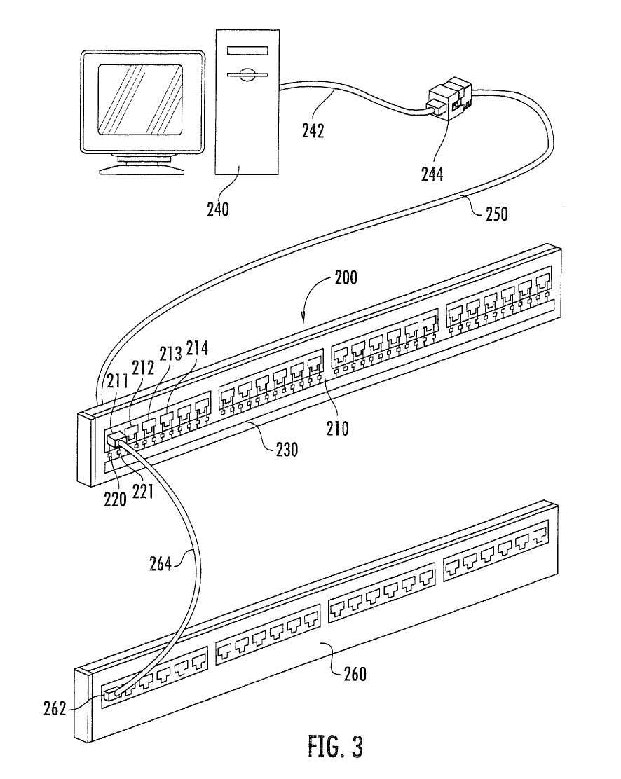

FIG. 3 depicts a communications patching system 200 according to certain embodiments of the present invention. As shown in FIG. 3, the communications patching system 200 includes a patch panel 210 and a processor 230. The patch panel 210 includes a plurality of connector ports 211-214. A first networked computing device 240 is connected to the back end of connector port 211 of patch panel 210 by a first patch cord 242, a wall jack 244 and a cable 250. A first connector port 262 on a switch 260 is connected to the front side of connector port 211 via a second patch cord 264. The back end of connector port 262 on switch 260 may be connected to downstream network devices such as routers, servers, etc. Patch cords 242, 264 and cable 250 each comprise eight conductive wires which are arranged as four twisted pairs of conductive wires. Each twisted pair of conductive wires is designed to carry one differential communications signal, and thus each of the patch cords/cables 242, 250, 264 is designed to carry four differential communications signals.

The first networked computing device 240 may comprise any electronic device that is configured to communicate over a communications network via wireless and/or wired communications. Examples of such networked computing devices include personal computers, printers, facsimile machines, internet telephones, servers, switches and the like. The switch 260 may comprise any network switch, router or similar device. It will likewise be appreciated that the first networked computing device 240 may communicate with some other network element other than a switch, router or the like.

The connector port 211 may comprise a conventional RJ-45 connector port that includes eight input terminals (e.g., eight jackwires) and eight output terminals (e.g., eight insulation displacement contacts or “IDCs”). The connector port 211 further includes eight conductive paths, where each conductive path electrically connects a respective one of the input terminals to a respective one of the Output terminals. The eight conductive paths act as four pairs of conductive paths, each of which may be used to carry one of the four differential communications signals that are carried on the conductive wires of cable 250 and patch cord 264. The input terminals, output terminals and conductive paths of connector port 211 are not visible in FIG. 3. It will be appreciated that connector port 211 may have any conventional configuration.

As is further shown in FIG. 3, a pair of probes 220, 221 are connected to connector port 211. A pair of probes 220, 221 are similarly provided for each of the remaining connector ports 212-214 of patch panel 210. Probe 220 may be connected to one or both of the conductive paths of a first of the four pairs of conductive paths in connector port 211. Alternatively, probe 220 may be connected to one or both of the input terminals or output terminals of the connector port 211 that correspond to the first of the four pairs of conductive paths. Probe 221 may be connected to one or both of the conductive paths (or corresponding input or output terminals) of a second of the four pairs of conductive paths in connector port 211. Probe 220 is connected to a one of the four pairs of conductive paths that carries signals transmitted by the first networked computing device 240, while probe 221 is connected to a one of the four pairs of conductive paths that carries signals transmitted by the switch 260.

As is also shown in FIG. 3, each of the probes 220, 221 is connected to the processor 230. In this particular embodiment, the processor 230 is implemented as part of the patch panel 210. It will be appreciated, however, that the processor 230 may be implemented as a stand alone device or as part of another device (e.g., as part of a rack manager that is mounted on the equipment rack that holds patch panel 210).

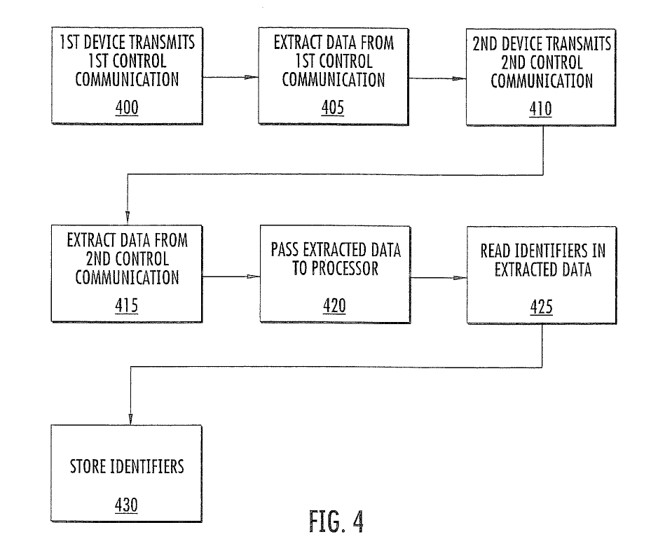

A method of automatically identifying within the communications patching system 200 identifiers associated with the networked computing devices that are communicating through a connector port on a patch panel that is part of the communications patching system will now be described with respect to FIG. 3 and the flow chart of FIG. 4. As shown in FIG. 4, operations may begin with the first networked computing device 240 of FIG. 3 transmitting a control communication to, for example, switch 260 (block 400). This control communication is carried on one of the four twisted pairs of conductive wires included in patch cord 242, through the wall jack 244, and onto one of the four twisted pairs of conductive wires included in cable 250, where it is passed onto a first of the four pairs of conductive paths in connector port 211. As discussed above, probe 220 is connected to the first of the four pairs of conductive paths in connector port 211. As such, probe 220 may be used to extract data from the first control communication that is transmitted by the first networked computing device 240 when that first control communication passes through connector port 211 (block 405).

Switch 260 may likewise transmit a second control communication to, for example, the first networked computing device 240 (block 410). This second control communication is carried on one of the four twisted pairs of conductive wires included in patch cord 264 where it is passed onto a second of the four pairs of conductive paths in connector port 211. The probe 221 is connected to the second of the four pairs of conductive paths in connector port 211 so that it may be used to extract data from this second control communication when the second control communication passes through connector port 211 on the second pair of conductive paths (block 415).

By including an identifier of the first networked computing device 240 in the first control communication and an identifier of the switch 260 in the second control communication, the probes 220, 221 can extract at the connector port 211 the identifiers of the “end” devices that are communicating through connector port 211 (i.e., the first networked computing device 240 and the switch 260). The extracted data that includes the identifiers is passed by the probes 220, 221 to the processor 230 which reads the identifiers (blocks 420, 425). In this manner, each of the connector ports 211-214 in patch panel 210 may automatically determine the identifiers of the “end” devices that are communicating through each respective connector port. (While switch 260 typically would not be the last device in the chain connected to the first networked computing device 240, it may still be considered an “end” device because it is the device that is transmitting the control communications that are received by the first networked computing device 240). The identifiers can then be stored along with the connector port/patch panel information in a database located, for example, at the patch panel, the rack on which the patch panel is mounted, in a stand alone computer or system manager and/or elsewhere in the communications patching system (block 430).

In some embodiments of the present invention, the identifiers that are extracted at the connector ports in the patch panel may be the MAC addresses of the networked computing devices that are communicating through each connector port (or, in the case of devices such as network switches that may have a single MAC address but a plurality of different ports or slots, the combination of the MAC address and a slot or port number). Moreover, as will be discussed below, in some embodiments, the identifiers may be transmitted by the networked computing devices as part of auto-negotiation communications between the networked computing devices.

In particular, when a first networked computing device is connected to a network via a hard-wired connection, the first networked computing device will typically be configured to automatically attempt to establish a communication link with the network switch or router when the first networked computing device is turned on and/or after it loses its network connection. When the first networked computing device is connected to the network via one or more wireless communications links, it might be possible that it could similarly attempt to establish a communication link with, for example, a wireless router at start-up and/or after its connection to the network is lost. A process known as “auto-negotiation” has traditionally been used to exchange information such as, for example, the highest common connection speed, necessary to establish such network connections.

Typically, the auto-negotiation process is carried out at the physical layer (layer 1) of the Open Systems Interconnection Basic Reference Model (“OSI Model”) for communications and computer network protocol design. As known to those of skill in the art, networked computing devices generally include a PHY chip (e.g., as part of a network card) that provides access to the physical link. The auto-negotiation process is typically performed by these PHY chips at the physical layer, without involvement from higher layers of the OSI model such as, for example, the link layer (layer 2). This auto-negotiation process occurs at link startup or during re-negotiation after the link is interrupted, when no other data is being transmitted.

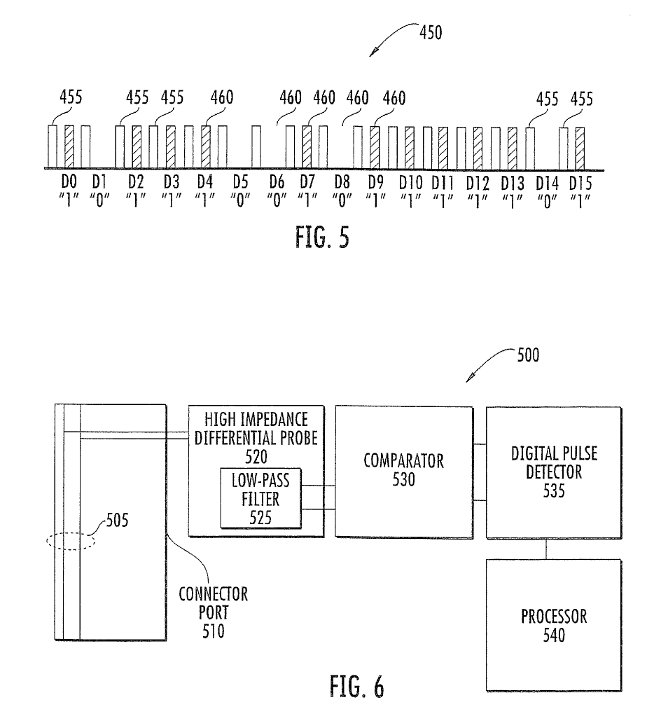

The auto-negotiation process is preformed by the PHY chip of the networked computing device and the PHY chip of the network switch or router. In some embodiments, these PHY chips exchange (i.e., one transmits, and the other receives) series of fast link pulses (called “FLP bursts”). FIG. 5 depicts an exemplary FLP burst 450. As shown in FIG. 5, the FLP burst 450 includes 32 pulses 455, 460. The pulses 455 comprise clock pulses, while the pulses 460 comprise data bits. Every other one of the pulses may be a clock pulse 455, and the clock pulses 455 always have a logic value of “1.” As shown in FIG. 5, the data pulses 460 may either have a logic value of “1” (i.e., the pulse is present) or a logic value of “0” (i.e., no pulse is present between the clock pulses). Thus, the FLP burst includes a total of sixteen data bits D0 through D15.

While the first FLP burst typically carries data such as connection speed information that is used to establish the network connection, the auto-negotiation process allows for additional FLP bursts that could contain additional information. According to some embodiments of the present invention, these subsequent FLP bursts may be used to transmit the identifier of the networked computing device that is communicating through a particular connector port of the communication patching system. As noted above, in some embodiments, the identifier may comprise a MAC address. All networked computing devices such as personal computers, printers, facsimile machines, servers, switches, memory storage units and the like have a distinct MAC address. This MAC address is included in the header of each packet of packet-switched communications that are transmitted by each networked computing device. Typically, the MAC address comprises a 6 byte (48 bit) identifier. With respect to devices such as switches and routers that have multiple cards or multiple ports that share the same MAC address, the transmitted identifier may also include a slot and/or port number in addition to the MAC address so that the communications patching system may track connectivity down to the port/slot level as opposed to just to the device level.

Assuming, for example, that eleven data bits are available in each subsequent FLP burst for carrying identifier data, it would generally be possible to transmit the full identifier in six to seven FLP bursts. In order to transmit the identifier, it would also be necessary to modify the PHY chips so that they would automatically transmit the identifier as part of the auto-negotiation process.

As discussed above, probes such as probes 220, 221 of FIG. 3 may be used to extract the identifiers from the control communications within the communications patching systems according to embodiments of the present invention. In some embodiments of the present invention, the probes 220, 221 may be implemented as current probes 220′, 221′. In such embodiments, current probe 220′ could be attached to one of the conductors of a first of the pairs of conductive paths in the connector port that carries the auto-negotiation signal from the first networked computing device 240 of FIG. 3 to switch 260 of FIG. 3. This current probe 220′ senses the current flowing through the conductor(s) to which the probe is attached, and does so in a manner that is relatively non-intrusive so as to not materially disturb or corrupt the signal flowing through the conductor(s). The current probe 220′ may include, for example, an inductive coil that generates a current in response to sensing the current flowing through the conductor to which the probe is attached, and this generated current varies according to the current flowing through the conductor. A resistor may be used to convert this generated current into a voltage. The voltage may be fed to an analog comparator that is used to determine whether each data bit embedded in the signal comprises a “1” or a “0.” In this manner, the current probe 220′ maybe used extract the data that is embedded in, for example, an auto-negotiation or other control communication that passes through the conductor(s) to which the probe 220′ is connected.

Likewise, current probe 221′ could be attached to one or both of the conductors of a second of the conductive pairs in the connector port that carry the auto-negotiation signal from the switch 260 of FIG. 3 to the first networked computing device 240 of FIG. 3 so as to similarly be used extract the data that is embedded in, for example, an auto-negotiation or other control communication that passes through the conductor(s) to which probe 221′ is connected. The data that is extracted by these current probes 220′, 221′ may then be fed to a processor such as processor 230 of FIG. 3 where the data may be read, logged in a database or other storage media, etc.

According to further embodiments of the present invention, the probes 220, 221 may be implemented as high impedance differential probes 220″, 221″. In such embodiments, each high impedance differential probe 220″, 221″ would be attached to each of the conductors of its respective pair of conductive paths in the connector port. The high impedance differential probes 220″, 221″ would generate a voltage signal in response to the control communication signal flowing through the pair of conductive paths in the connector port to which the probe is attached, thereby extracting data (including the identifier) from the control communication signal. Once again, this voltage would be appropriately processed and fed to a processor where the data could be read and stored. It will likewise be appreciated that other types of probes and other methods for extracting the identifier may be used.

FIG. 6 is a block diagram that illustrates one embodiment of an extraction circuit 500 that may be used to extract a device identifier from, for example, an auto-negotiation communication. As shown in FIG. 6, the auto-negotiation signal is carried on a differential pair of conductive paths 505 that is part of a connector port 510. A high impedance differential probe 520 is attached to each of the conductors of the differential pair 505. As shown in FIG. 6, the high impedance differential probe 520 may include a low pass filter 525 that filters the voltage signal generated by the high impedance differential probe 520 in response to a signal that flows on the differential pair 505. The output of the low-pass filter 525 is fed to a comparator 530. The comparator 530 compares the output of the low pass filter to a reference (e.g., 0 volts) and generates a pulse train in response thereto that corresponds to the data embedded in the signal carried on the differential pair 505. The pulse train generated by the comparator 530 is fed to a digital pulse detector 535 that is used to convert the pulses output by the comparator 530 into binary digital data, which is then fed to a processor 540.

The processor 540 may be programmed such that the processor is able to identify the specific communications that contain device identifiers and the specific data in such communications that comprise the identifier. The processor 540 is also able to distinguish between these control communications and other normal communications. The processor 540 may also be programmed to know both the patch panel (or other patching device) and connector port that differential pair 505 is part of; in this manner, the processor 540 may read the identifier from the control communication that is transmitted over differential pair 505 to automatically determine the identifier of the networked computing device that transmitted the signal. The processor 540 may be coupled to, for example, a database in which the identifiers of each end device that are connected to the connector ports in the communications patching system are stored.

In embodiments of the present invention, the probes 220, 221 are provided either as part of the connector port or attach directly to the connector port. By way of example, the connector port may include additional auxiliary input terminals for the lead(s) of each probe, and these auxiliary input terminals may be electrically connected to the appropriate conductors (e.g., via traces on a printed circuit board of the connector port). It will be appreciated in light of the present disclosure, however, that the probes 220, 221 may be connected to the differential pair elsewhere in the communication patching system. By way of example, in some embodiments the probes could be connected directly to the cable that attaches to the back end of the connector port. Thus, while the probes will likely be typically implemented at the connector ports, the present invention is not so limited.

Likewise, while specific embodiments of the present invention have been discussed above that use MAC addresses as identifiers, it will be appreciated that many other implementations are possible. In fact, embodiments of the present invention may use any appropriate device identifiers—MAC addresses (along with corresponding slot/port information, if appropriate) are just an example of one convenient type of identifier that may be used. Similarly, while specific embodiments of the present invention have been discussed above that use auto-negotiation control communications as the communications in which the identifiers are embedded, it will be appreciated that other control communications could be used, including custom communications that are specifically designed for transmitting device identifiers or other control communications that are exchanged at link start-up or at other times.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A method of identifying a first networked computing device that is connected to a connector port of a communications patching system, the method comprising:
passing a control communication that is transmitted by the first networked computing device through the connector port;
extracting an identifier associated with the first networked computing device from the control communication; and
logging the identifier in a connectivity database that associates the identifier with the connector port.

2. The method of claim 1, wherein the identifier is extracted at the connector port.

3. The method of claim 2, wherein the identifier is extracted using a probe that is connected to at least one conductor of a differential pair of conductors that pass the control communication through the connector port.

4. The method of claim 3, wherein the probe comprises a current probe or a high impedance differential probe.

5. The method of claim 1, wherein the connectivity database tracks connectivity information within the communications patching system.

6. The method of claim 1, the method further comprising:
passing a second control communication that is transmitted by a second networked computing device through the connector port;
extracting a second identifier that is associated with the second networked computing device from the second control communication; and
logging the second identifier in the connectivity database.

7. The method of claim 6, wherein the second identifier is extracted using a second probe that is connected to at least one conductor of a second differential pair of conductors that pass the second control communication through the connector port.

8. The method of claim 7, wherein the second identifier comprises a MAC address associated with the second networked computing device and a port number of a connector port on the second networked computing device.

9. The method of claim 1, wherein the control communication is an auto-negotiation communication that comprises at least one burst of fast link pulses.

10. The method of claim 1, wherein the identifier comprises a MAC address.

11. A method of identifying a first device that is connected through a communications patching system, the method comprising:
extracting at a connector port of a patch panel of the communications patching system an identifier associated with the first device that is embedded within a control communication that is transmitted from the first device to a second device via the connector port.

12. The method of claim 11, wherein the identifier comprises a MAC address of the first device.

13. The method of claim 11, wherein the control communication is an auto-negotiation communication that is transmitted at the physical layer of the network protocol without input from higher layers of the network protocol.

14. The method of claim 11, wherein the identifier is extracted using a probe that is connected to at least one conductor of a differential pair of conductors that are part of the connector port.

15. The method of claim 14, wherein the method further comprises reading the identifier from an output of the probe and logging the read identifier in a database that associates the identifier with the connector port.

16. A communications patching system, comprising:
a patch panel that comprises a plurality of connector ports and a plurality of probes, wherein each probe is configured to extract information from control communications that are transmitted through a respective one of the connector ports that is associated with the probe; and
a processor, wherein the processor is coupled to the plurality of probes and is configured to read device identifiers that are contained within the extracted information.

17. The communications patching system of claim 16, wherein the connector ports comprise RJ-45 style connector ports that each include at least eight conductive paths, and wherein each of the plurality of probes comprises a current probe that is connected to at least one of the conductive paths of its respective connector port.

18. The communications patching system of claim 16, wherein the connector ports comprise RJ-45 style connector ports that each include at least eight conductive paths, and wherein each of the plurality of probes comprises a high impedance differential probe that is connected to two of the conductive paths of its respective connector port.

19. The communications patching system of claim 16, further comprising a plurality of comparators, wherein each comparator is connected between a respective one of the probes and the processor.

20. The communications patching system of claim 19, further comprising a plurality of digital pulse detectors, wherein each digital pulse detector is connected between a respective one of the comparators and the processor.
